(19) United States
(12) Patent Application Publication
(10) Pub. No.: US 2005/0184103 A1
(43) Pub. Date: Aug. 25, 2005

(54) Loss-in-weight feeder for powders and dry goods

(76) Inventors: Giuseppe Palma, Busto Arsizio (IT); Gianluigi Riva, Milano (IT)

Correspondence Address: David George Johnson, Post Office Box 286, Aitkin, MN, 56431, US

(21) Appl. No.: 11/016,582

(22) Filed: Dec. 17, 2004

(30) Foreign Application Priority Data
Dec. 19, 2003 (EP) 03425814.5

(51) Int. Cl. G01F 11/20

(52) U.S. Cl. 222/413

(57) ABSTRACT

In a loss-in-weight feeder comprising a product dispensing hopper (3) and a case containing a kinematic motion (15) for driving a dispensing screw (6) by means of a motor (4), case and hopper are spaced at a sufficient length for a thrust bearing (16) supporting the screw to be positioned therebetween at a sufficient distance from the hopper to prevent the product from coming into contact with thrust bearing.

### FIELD OF THE INVENTION

The present invention relates generally to a loss-in-weight feeder for powders and dry goods, and more particularly to a feeder containing a bearing which may be present when processing a relatively abrasive substance.

### BACKGROUND OF THE INVENTION

Loss-in-weight feeders for powders and dry goods are used in many different industries to accurately dose powdered, particulate or granular matters in movement. They are preferred to other continuous weighing techniques such as conveyor belt feeders, screw feeders, vibrating plate feeders, Coriolis Effect feeders and others, because they allow to modulate rates of very small entity with high precision. They are also space saving and easy to install.

A loss-in-weight feeder is a part of a loss-in-weight feeder assembly consisting of three basic elements, namely precision static scales, the feeder itself and the electronic control instrument. The feeder consists of a hopper containing the material to be dosed, an extractor usually consisting of one or two worm screws, a lump breaker favouring the flow of the material, and one or two motors driving both the screws and the lump breaker and connected to the electronic control instrument.

The whole assembly is supported by a static scale which constantly measures the overall weight of the feeder as well as the material contained therein and sends the related data to the electronic control instrument.

Upon operation of the motor, the screw or screws extract the material from the hopper at a rate which is proportional to the speed of rotation of the screws and depends on the system dimensional geometric factors. By suitably modulating the rotation speed of the screws the desired rate, either constant or variable, is obtained.

The rate is measured by the electronic instrument, which at preset time intervals measures the reduction in weight of the system, and calculates the ponderal rate by dividing the amount of weight lost by the system by the time taken to lose it. Suitable electronic filtering systems allow stabilizing the measurement in the presence of vibrations, abrupt changes in weight, etc. Loss-in-weight feeders such as those described above have been on the market for years, and are manufactured for different industrial applications. The present invention relates to feeders for dry goods and in particular for dry goods in the food industry.

State of the art feeders have several drawbacks. In particular, in the foods industry it is very important to avoid stagnation or infiltration of the dosed product both inside the feeder and the mechanical parts thereof and to have the possibility of cleaning the feeder thoroughly.

For this purpose it is already known to place the kinematic motion, i.e. the gears assembly, driving the screw and lump breaker rotation inside an outer case (or container) which is independent from the hopper containing the material to be dosed. Nevertheless, the feeders known in the foodstuffs industry are prone to contamination and must be frequently dismantled and cleaned; the resulting interruptions in the production cycle increase production costs. Another drawback is related with the treating of sugar and similar highly abrasive materials: in this case the treated product can quickly wear out the components of the gear and motor assembly.

U.S. Pat. No. 5,110,015 discloses a seal arrangement for a dry good material feeder by extending the screw into a duct extending from the hopper to the gear and motor assembly: the bearing is positioned within this duct and supports a shaft that is coupled to the screw by a pin and locking recesses with a helical spring keeping the pin locked in the recesses. This arrangement is however not effective for preventing the dry, powder, material to reach the bearing and the locking elements.

In fact, U.S. Pat. No. 5,110,015 is referred to by later patent U.S. Pat. No. 5,715,976, that discloses a cartridge bearing assembly for a dry good material feeder in which a duct extends from the hopper and a bearing support assembly is removably mounted in the duct for supporting a drive shaft. This shaft is coupled to the screw by means of a pin on the shaft, guide slots and locking recesses on the screw and a helical compression spring to keep the pin locked into the locking recesses. The problem to be solved by this patent is to reduce the time (and the cost) required for replacing the bearing according to U.S. Pat. No. 5,110,015, that are said to last no longer than 200-220 hours, thus acknowledging that the sealing arrangement of the previous patent is not so effective.

Both the above mentioned embodiments, if used in the food industry, will require long cleaning times and, because of their design, could result in contamination of the food product. Moreover, the service life of the bearings is too short.

Therefore, the need is felt for a feeder, particularly for use in the food industry, in which no infiltrations or contamination of the product in the gears occur and in which all parts can be easily cleaned in order to prevent the forming of perishable product residues that could result in the formation of germs, and which is able to treat highly abrasive materials without having to often replace the bearings.

The aim of this invention is to solve the above mentioned drawbacks and to provide a feeder with the required features.

This aim is achieved by the present invention, which concerns a loss-in-weight feeder according to claim 1. The feeder of the invention comprises a hopper housing at least one product dispensing screw; at least one motor for driving the said dispensing screw or screws; at least one gear assembly, housed in a container and comprising a shaft connecting said screw to said motor; and means for coupling said dispensing screw(s) to said moving part comprising a drive shaft to be coupled to the dispensing screw and a bearing for said shaft. According to the invention the hopper and the container housing the gears assembly, i.e. the kinematic motion means, are spaced away from one another, a duct extends from the bearing to the hopper, the shaft extends outside the duct into the box for the gears assembly and the bearing is spaced away from the hopper and outside the duct. Preferably, the bearing is a thrust bearing and is located in the gear assembly box.

According to one aspect of the invention, sealing means are provided at the end of the duct to seal the shaft outside the gear assembly box or container.

According to another aspect of the invention, the distance between said sealing means and said hopper is greater than the distance reached by the product to be dispensed because of its natural angle of rest inside said duct.

According to another aspect of the invention, the dispensing screw extends outside said hopper, inside said duct, in the direction of the thrust bearing.

A further feature of the invention is that the drive shaft is axially coupled to the screw or auger shaft by means of a pin axially extending from the drive shaft and received in a corresponding housing or recess extending longitudinally, i.e. axially, in the screw or auger shaft. There is no spring or other elastic means to keep the drive shaft connected to the screw: once it has been assembled, the screw is biased, i.e. pushed, against the drive shaft by the discharge chamber so as to remain engaged to said shaft.

The feeder according to the invention has several advantages over prior art.

By spacing the facing walls of the material-containing hopper and of the box or container housing the kinematic motion means, i.e. the gears assembly, which drives the shaft of the product dispensing auger screw and by placing the thrust bearing for supporting the screw and the relevant drive shaft in the space formed thereby or, preferably, within the gear assembly box, the contact between the bearing (and the relative seal or gasket) and the product to be dispensed can be dramatically reduced or completely eliminated. Substantially reducing or preventing this contact results in longer life of the bearing, particularly when the product to be treated is abrasive, such as sugar, and it greatly reduces or even prevents the possibility of an infiltration and stagnation of the product around and in the bearing itself.

In addition, the feeder according to the invention can be easily and rapidly cleaned; a sufficient distance will allow for a very accurate cleaning, such as by hand, of the facing walls of both the hopper and the gear assembly box. A further advantage in cleaning is that the means coupling the drive shaft to the auger are spaced from the bearing and are located within the duct, while the bearing is located outside the duct: when cleaning is necessary, the augers are removed from the drive shaft by removing the delivery chamber and pulling the screw away from the drive shaft. The relevant area can then be cleaned in a very effective way by e.g. pressurised jets of cleaning solution and water; these pressurised jets could not be used in the above discussed prior art embodiments because of the risk of pushing the powder material into the bearing under the jet pressure.

The invention will be now disclosed in greater detail in an illustrative and non-limiting manner with reference to the accompanying figures, wherein:

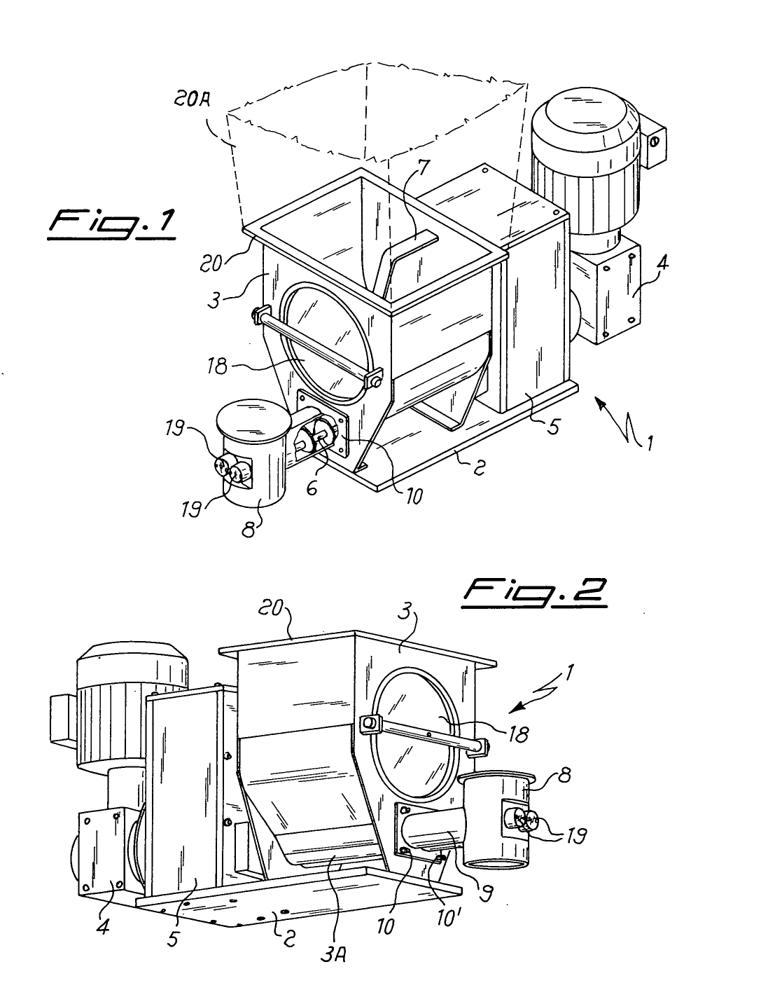

FIG. 1 is a schematic top perspective view of a feeder according to the invention;

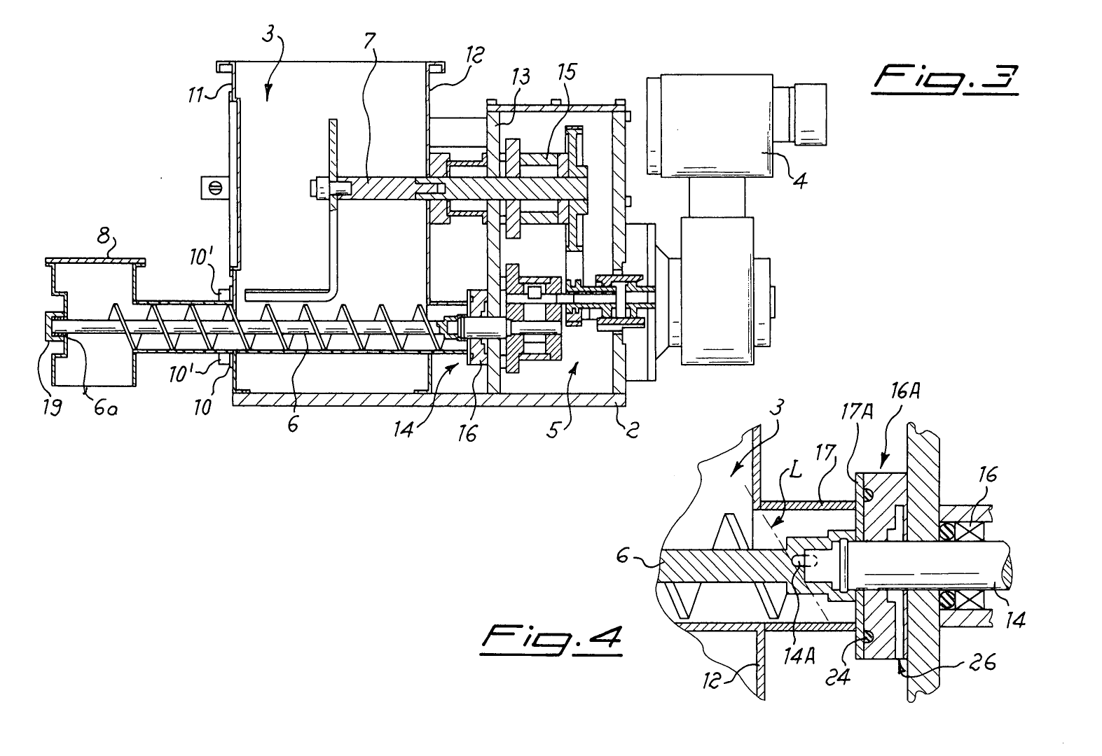

FIG. 2 is a schematic bottom perspective view of the feeder in FIG. 1;

FIG. 3 is a schematic cross-sectional side view of the feeder of the above figures;

FIG. 4 is an enlarged view of a detail of the feeder in FIG. 3;

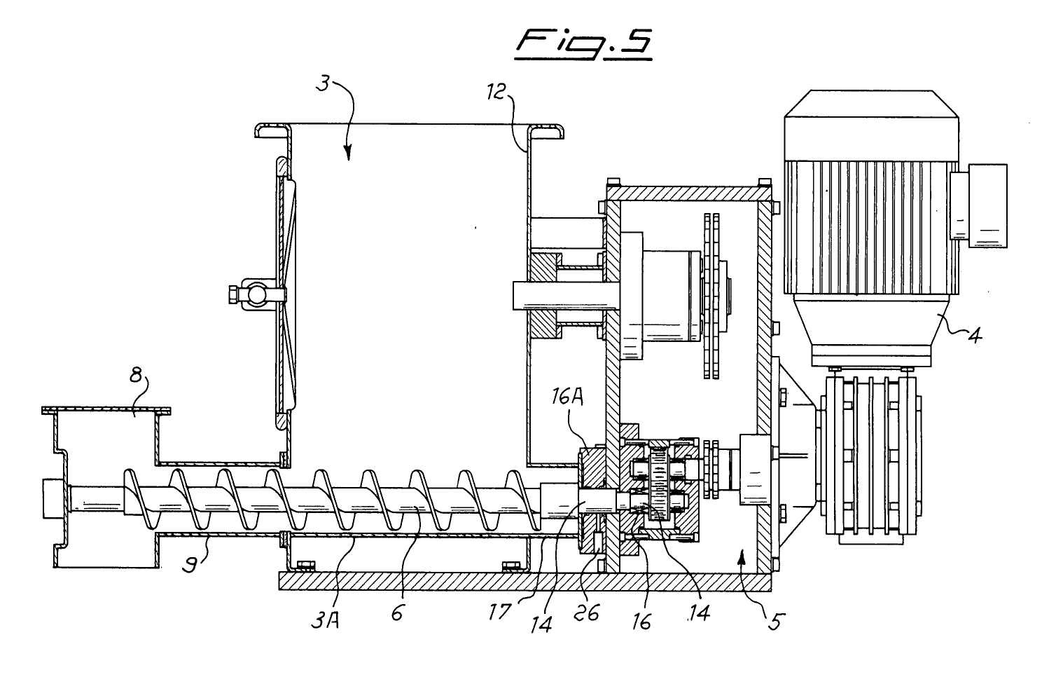

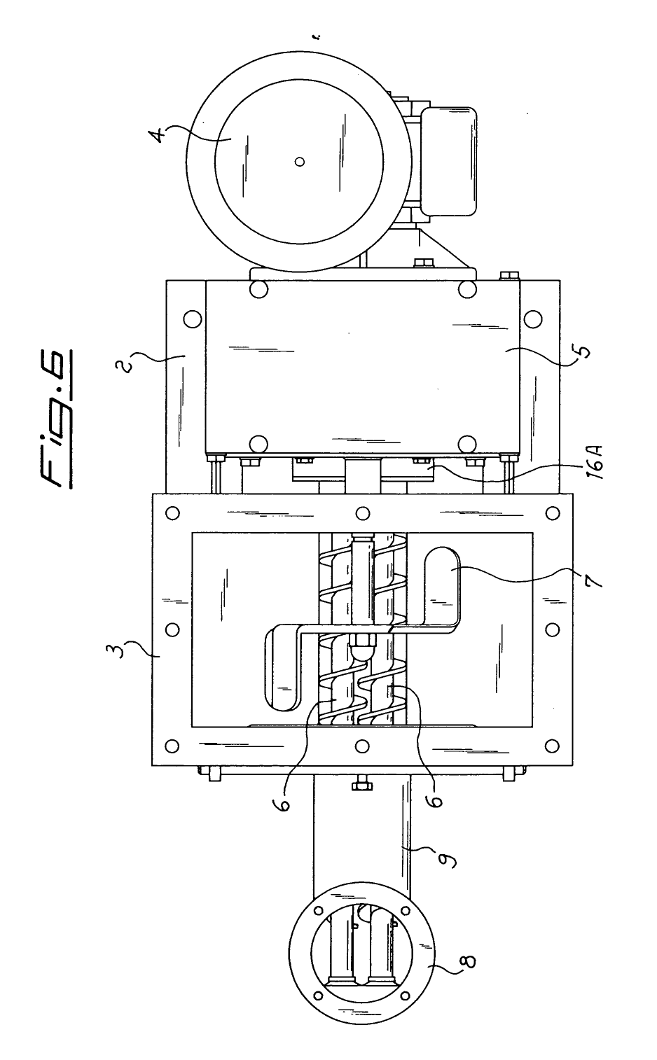

FIG. 5 is an enlarged side view, partially sectional, of the embodiment of FIG. 3;

FIG. 6 is an enlarged top view of the feeder of FIG. 6;

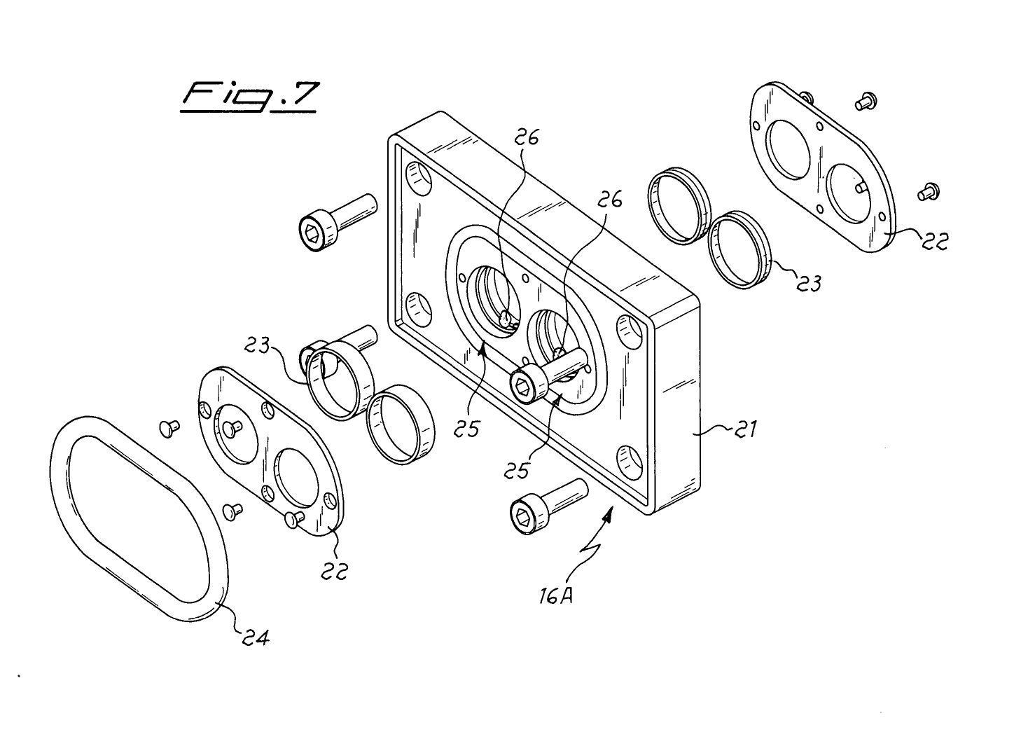

FIG. 7 is a perspective, exploded view of a sealing means of the drive shaft for the auger screws.

With reference to the above figures, the feeder 1 according to the invention comprises a base 2 to which a hopper, or tray, 3 is mounted into which the product to be dosed is poured, and a box or container 5 containing the gears assembly, i.e. the kinematic motion, connecting the motor to the driven feeder elements, and at least one motor 4, cantilever mounted on box 5. The motor 4 and gear assembly 5 are a motor-speed variator-reducer gear unit driving at least one product dispensing worm screw, or auger, 6 and a lump breaker 7. In the shown embodiment there are two screws 6, which are located at the bottom of the hopper or tray 3 in a correspondingly shaped area. As shown in FIG. 6, the two augers or screws are mounted parallel and the flights or turns of helix of one screw are positioned within the helix turns of the other screw, without ever touching each other during operation of the feeder.

The hopper has a front wall 11 and a rear wall 12, i.e. a wall facing box 5. Screws 6 extend through front wall 11 outside hopper 3 into a discharge, or delivery, chamber 8, preferably shaped as a cylinder. The portions of the screws protruding from the front wall 11 of the hopper 3 are housed in a double duct 9 connecting the discharge chamber 8 with hopper 3; the duct 9 is welded or otherwise made integral with the chamber 8 at one end and is mounted on the hopper 3 by means of a flange 10 and relative nuts and bolts 10′ at the other end, in order to be quickly detached from the hopper when the feeder has to be cleaned. The ends 6a of the screws 6 are rotatably housed in corresponding recesses 19 formed on the front side of discharge chamber 8.

The hopper 6 comprises an upper peripheral flange 20 to detachably support an additional hopper 20A formed by four walls being mounted on dispensing hopper 3 in order to feed the product to the dispensing hopper 3. The additional hopper 20A is shown in dotted lines in FIG. 1. The interior of hopper 3 can be reached for inspection and cleaning through a hatch 18 positioned on the front wall 11.

On the opposite side to the front wall 11 of the hopper 3, the screw 6 extends through rear wall 12 into a duct 17. Duct 17 runs from the bearing and bearing sealing group 16, 16A to the wall 12 of the hopper 3 and houses one end of the dispensing screw 6 and a portion of the means 14 coupling the auger or feeding screw 6 to the gears assembly 15. Auger 6 is engaged to means 14, i.e. a drive shaft, that engage it to the gears assembly, or kinematic motion means, 15 provided inside box 4, the means 14 comprising a thrust bearing 16 with relative sealing means 16A.

According to the present invention, the box or container 5 and the hopper 3 are spaced from one another by a sufficient distance for the thrust bearing, including sealing means, to be placed therebetween, this bearing being also spaced away from the rear wall 12 of the hopper and outside the duct 17. Particularly, the distance between the bearing 16 and the wall 12, i.e. the length of duct 17 is such to reduce or prevent the contact between the bearing and the product to be dispensed. Preferably, as better shown in FIG. 4, the bearing 16 is located inside the box 5 and the sealing means 16A are located between box 5 and duct 17, outside said duct. In other words, the bearing and the sealing means for the drive shaft can be located both between box 5 and duct 17 or, preferably, bearing 16 is located within the box 5 and sealing means 16A is located outside duct 17, between duct 17 and box 5.

The diameter of the duct 17 is the smallest possible compatibly with the dimension of what is housed in said duct, in other words an end of the dispensing screw 6 and a portion of the drive shaft means 14 connecting the screw to the gear assembly 15. In the preferred embodiment shown in FIG. 4 and FIG. 5 the screw extends beyond wall 12, outside the hopper, into the duct 17, to obtain an expulsion action (by means of the screw flights) of the product that penetrates into duct 17.

Preferably, the distance between the bearing sealing means 16A and the duct end 17 i.e. the hopper 3, is greater than the distance reached by said product inside the duct 17 due to its natural angle of rest. In FIG. 4 the natural angle of rest taken by the product inside the duct 17 is shown with line “L”: as it can be seen, even at rest, i.e. with the screw stopped, the product does not come into contact with sealing means 16A. The length of the duct 17 is in generally set to be greater than the maximum distance that may be reached by any product inside the duct itself, taking into account for which products the feeder will be used.

Thus, the duct 17 together with its length, in other words together with the part separating the sealing means 16A from the hopper 3, form further sealing means that prevent the product from coming into contact with the bearing 16.

In FIG. 4 it is also shown the preferred way of coupling drive shaft 14 to auger 6. This is obtained by means of a pin 14A protruding axially, i.e. longitudinally, from the end of drive shaft 14 into a corresponding recess axially extending into the screw body to provide a housing within the auger, or feeding screw, 6. The thus reached coupling is an axial coupling, free of any spring or elastic means and is based on the fact that the pin 14A will transmit the torque to auger 6. In order to prevent auger 6 to detach from shaft 14, the auger is kept in place against drive shaft 14 by the action of previously disclosed discharge chamber 8, that is rotatably housing the other end of auger 6 in recesses 19. In other words, the length of auger 6 is such that when the auger is mounted it is fitting on drive shaft 14, possibly slightly pushed against it.

FIG. 7 shows an embodiment of sealing means 16A. This means is comprising a main box body 21 having two holes 25 for the two augers shafts, two plates 22 and four rings or gaskets 23 for sealing holes 25, and a gasket 24 for sealing the box 21 against the wall 17A that closes duct 17. At least one duct 26 is provided within box 21 to connect the walls of holes 25 with the exterior (see also FIG. 4) in order to feed a pressurized fluid, e.g. pressurized air, to the holes and improve the overall sealing effect of sealing means 16A. in other words, a pneumatic seal is obtained, wherein the pressurized air flow contributes to the sealing of shaft 14.

In this way it is possible to dramatically increase the service life of thrust bearing 16; the life is in fact extended from the 220 hours of cited prior art documents to about 6.000 hours. This is possible thanks to the positioning of the bearing outside the duct and preferably inside the gear assembly box 5, with sealing means located between the end of the duct and the box.

The feeder according to the present invention can be cleaned in a very simple and easy way.

When necessary, the nuts 10′ can be unscrewed and the ducts 9 removed, together with discharge chamber 8 and augers or screws 6, from hopper 3. More particularly, the screws 6 are removed from corresponding shafts 14 by simply pulling them away from pin 14A. As a matter of fact, contrary to known prior art embodiments, the screws are detachable and can be removed from the front side while the bearing 16 for the screws and the drive shaft 14 are fixed. The screws are then removed from ducts 9 and the feeder can be thoroughly cleaned and sanitized both outside and inside, e.g. with pressurized jets, in a very quick and effective way.

As far as the exterior is concerned, the distance between wall 12 of the hopper 3 and wall 13 of the case 5 is preferably enough to have also a manual cleaning of the walls carried out.

1. Loss-in-weight feeder, comprising a hopper (3) in which is housed at least one product dispensing screw (6), at least one motor (4) for operating said dispensing screw or screws (6), at least one gear assembly (15) connecting said screw to said motor, coupling means for connecting said screw (6) to said gear assembly (15) comprising a drive shaft (14) and a bearing (16) for said drive shaft, wherein said gear assembly is housed in a box (5) spaced from said hopper (3), said bearing (16) is arranged, spaced away from said hopper, between said hopper (3) and said gear assembly, and a duct (17) extends from said hopper (3) towards said bearing (16), said bearing being located outside said duct (17).

2. The feeder according to claim 1, wherein said bearing (16) is located inside said gear assembly box (5) and sealing means (16A) are provided outside said duct (17), between said duct and said gear assembly box (5).

3. The feeder according to claim 1 or 2, characterized in that the distance between said bearing (16) and said hopper (3) is greater than the distance reached by said product because of its angle of natural rest (L) inside said duct (17).

4. The feeder according to claim 1, wherein said dispensing screw (6) is extending outside said hopper (3), inside said duct (17), in the direction of said bearing (16).

5. The feeder according to claim 1, wherein the distance between said hopper (3) and said gear assembly box is sufficient to allow manual cleaning thereof.

6. The feeder according to one claim 1, wherein said dispensing screw (6) extends outside said hopper (3) to a discharge chamber (8) and wherein said hopper (3) and said discharge chamber (8) are connected by a housing duct (9) of the dispensing screw, said housing duct (9) being detachably mounted (10, 10′) on said hopper (3).

7. The feeder according to claim 6, wherein said drive shaft (14) is fixed and said screw (6) is detachably mounted on said drive shaft (6).

8. The feeder according to claim 7, wherein said drive shaft is provided with a pin axially extending from said drive shaft and said screw is provided with an axially extending recess for said pin (14A) to axially coupled said screw to said drive shaft (14).

9. The feeder according to claim 2, wherein said sealing means (16A) for said drive shaft comprises means (26) for feeding pressurized air to an area around said drive shaft (14).

10. The feeder of claim 1, wherein two parallel screws are provided, the flights of one screw being positioned between the flights of the other screw.
